(19) United States
(12) Patent Application Publication
(10) Pub. No.: US 2025/0361984 A1
(43) Pub. Date: Nov. 27, 2025

(54) TANK, AND METHOD OF PRODUCING TANK

(71) Applicant: TOYOTA JIDOSHA KABUSHIKI KAISHA, Toyota-shi (JP)

(72) Inventor: Kazuki FUJII, Toyota-shi (JP)

(73) Assignee: TOYOTA JIDOSHA KABUSHIKI KAISHA, Toyota-shi (JP)

(21) Appl. No.: 19/294,254

(22) Filed: Aug. 7, 2025

Related U.S. Application Data
(62) Division of application No. 18/473,725, filed on Sep. 25, 2023.

(30) Foreign Application Priority Data
Oct. 5, 2022 (JP) 2022-160840

(51) Int. Cl. F17C 1/16

(52) U.S. Cl. CPC F17C 1/16; F17C 2201/0109; F17C 2203/0604; F17C 2203/066; F17C 2205/0305; F17C 2209/2109

(57) ABSTRACT

Provided is a tank that can improve the adhesion between a mouthpiece and a liner. The tank includes: a liner; and a mouthpiece disposed at an opening part of the liner, the mouthpiece having a hole, wherein the liner has an inner face part that is a part extending around an inner face of the hole of the mouthpiece from an opening part of the hole of the mouthpiece, and an outer face part that is a part extending around an outer face of the mouthpiece from the opening part of the hole of the mouthpiece, and at an end part of the inner face part, crystallinity of the liner distributes in a dispersing state but not in a form of layer.

### CROSS-REFERENCE TO RELATED APPLICATION

This is a divisional application of U.S. patent application Ser. No. 18/473,725, filed Sep. 25, 2023, which claims priority to Japanese Patent Application No. 2022-160840 filed on Oct. 5, 2022, incorporated herein by reference in its entirety.

### FIELD

The present disclosure relates to a tank, and a method of producing a tank.

### BACKGROUND

Patent literature 1 discloses the structure of a tank such that a liner is placed around a mouthpiece.

Patent literature 2 discloses that a liner groove inside a mouthpiece is provided with plural holes to prevent a fall from the liner groove.

### CITATION LIST

### Patent Literature

Patent Literature 1: JP H11-210988 A
Patent Literature 2: JP 2012-514727 A

### SUMMARY

### Technical Problem

A fixed interface between a mouthpiece and a liner is aimed at guaranteeing the sealability of a tank. The strength of the adhesion between the mouthpiece and the liner is however low, and it is necessary to increase this adhesive strength for guaranteeing the sealability.

An object of the present disclosure is to provide a tank that can improve the adhesion between a mouthpiece and a liner. A production method for this is also provided.

### Solution to Problem

Upon founding out that, as a result of his intensive research, fracture easily develops under sheer stress to decrease the strength of the adhesion between a mouthpiece and a liner when the crystallinity of the liner distributes in the form of layer in the flowing direction of a liner resin, the inventor completed the present disclosure.

The present application discloses a tank comprising: a liner; and a mouthpiece disposed at an opening part of the liner, the mouthpiece having a hole, wherein the liner has an inner face part that is a part extending around an inner face of the hole of the mouthpiece from an opening part of the hole of the mouthpiece, and an outer face part that is a part extending around an outer face of the mouthpiece from the opening part of the hole of the mouthpiece, and at an end part of the inner face part, crystallinity of the liner distributes in a dispersing state but not in a form of layer.

The liner may have a gate trace at the outer face part.

The present application also discloses a method of producing a tank, the method comprising: disposing, in a metal mold, a mouthpiece having a hole; and pouring a resin into the metal mold via a gate, wherein said pouring a resin causes the resin to separate to flow into a channel around an inner face of the hole of the mouthpiece from the gate, and a channel around an outer face of the mouthpiece from the gate.

### Advantageous Effects

According to the present disclosure, there is a part where the crystallinity of the liner does not distribute in the form of layer at the end part. Therefore, fracture does not easily develop even under shear stress, and the strength of the adhesion between the mouthpiece and the liner can be improved.

### BRIEF DESCRIPTION OF DRAWINGS

FIG. 1 shows an external appearance of a tank;

FIG. 2 is a partial cross-sectional view of the tank;

FIG. 3 is a partially enlarged view of FIG. 2;

FIG. 4A shows an example of crystallinity distributing in a dispersing state, and FIG. 4B shows an example of crystallinity distributing in the form of layer;

FIG. 5A shows an example of orientation distributing in a dispersing state, and FIG. 5B shows an example of orientation distributing in the form of layer; and

FIG. 6 illustrates insert molding.

### DESCRIPTION OF EMBODIMENTS

### 1. Structure of High-Pressure Tank

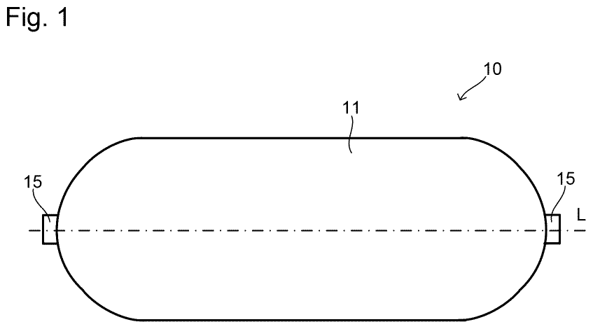

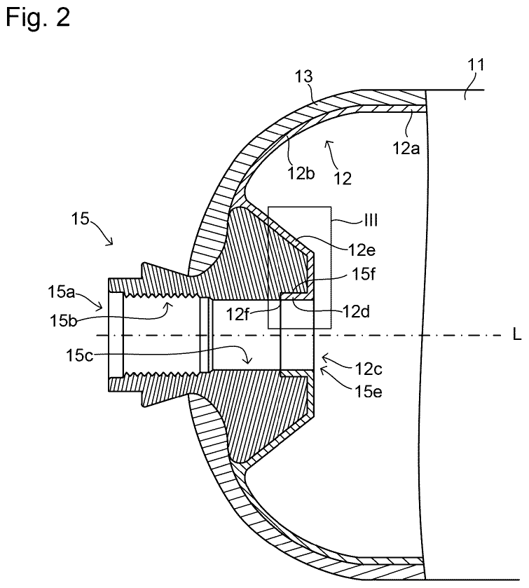

FIG. 1 schematically shows an external appearance of a high-pressure tank 10 according to one embodiment. FIG. 2 shows a partial cross section of the high-pressure tank 10 taken along the axis L: this partial cross section includes a part around one of mouthpieces 15 to which a valve is to be fitted. As can be seen from these drawings, in this embodiment, the high-pressure tank 10 includes a tank body 11 and the mouthpieces 15. The structure of each of them will be described below.

### 1.1. Tank Body

The tank body 11 holds a matter to be housed therein (such as hydrogen) without a leak, and has enough strength to bear a high-pressure state thereinside. Therefore, in this embodiment, the tank body 11 is provided with a liner 12, and a reinforcing layer 13 disposed around the periphery of the liner 12.

### 1.1.1 Liner

The liner 12 is a hollow member defining the space inside the high-pressure tank 10, and in this embodiment, is cylindrical. The liner 12 is such that the openings at the respective ends of a trunk 12a thereof which has an approximately uniform diameter are narrowed by dome-like side end parts 12b thereof, and the mouthpieces 15 are disposed at narrowed openings 12c thereof.

Any known material can be used for the liner 12 as long as allowing the matter housed in the internal space of the liner 12 (such as hydrogen) to be held without a leak. Specifically, for example, the liner 12 is formed from a nylon resin, or a polyethylene synthetic resin.

The thickness of the liner 12 is not particularly limited, and is preferably 0.5 mm to 1.0 mm.

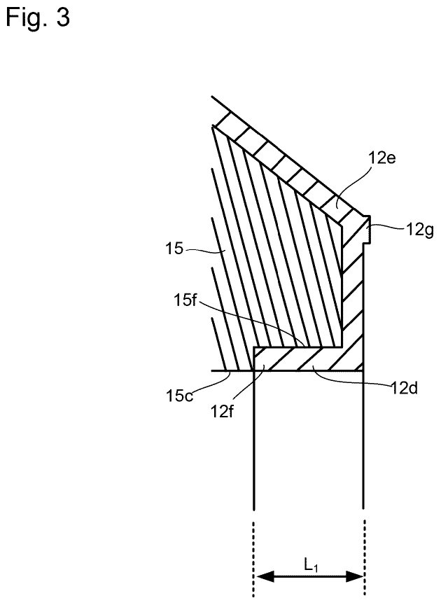

A part of the liner 12 which is in contact with one of the mouthpieces 15 has the following form. In FIG. 3, the part indicated by III in FIG. 2 is enlarged. As can be seen from FIGS. 2 and 3, the liner 12 includes an inner face part 12d that is a part extending around an inner face of a hole 15a of the one of the mouthpieces 15 from an opening part 15e on the tank body side of the hole 15a of the one mouthpiece 15, and an outer face part 12e that is a part extending around the outer face of the mouthpiece 15 which is inside the tank body from the opening part 15e of the hole 15a of the mouthpiece 15.

Here, the inner face part 12d is placed along a steplike part 15f that is formed by increasing the diameter of the mouthpiece 15 on the opening part 15e side. The size Li of the inner face part 12d which is along the axis L is not particularly limited, and is preferably at least 6 mm. This can lead to the crystallinity in the liner resin distributing in a dispersing state but not in the form of layer at an end part 12f of the inner face part 12d as described later.

In contrast, the outer face part 12e of the liner 12 is a part of the side end part 12b of the liner 12 which covers the outer face of the mouthpiece 15 inside the tank body 11.

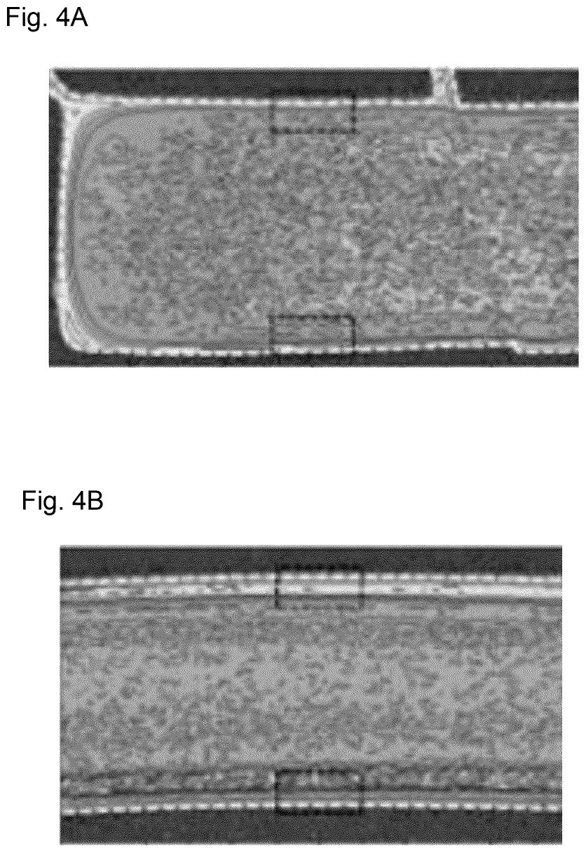

Here, the crystallinity distributes in a dispersing state but not in the form of layer at least at the end part 12f of the inner face part 12d of the liner 12. The crystallinity distributing in a dispersing state but not in the form of layer refers to the crystallinity distributing in a dispersing state but not forming layers as shown in FIG. 4A, which shows the distribution of the crystallinity. In contrast, as shown in FIG. 4B, which shows the distribution of the crystallinity, the crystallinity may distribute in the form of layer in a part of the inner face part 12d which excludes the end part 12f, and the outer face part 12e of the liner 12. The present disclosure is not limited to this. The crystallinity may distribute in a dispersing state in the part of the inner face part 12d which excludes the end part 12f, and part or all of the outer face part 12e of the liner 12.

Here, “crystallinity” means the degree of crystallinity, and “the distribution of the crystallinity” means the distribution of the degree of crystallinity. When the crystallinity is in the form of layer, crystals of approximate degrees of crystallinity gather to form a layer. When the crystallinity distributes in a dispersing state, crystals of various degrees of crystallinity are mixed but are not in the aforementioned form of layer. The degree of crystallinity is obtained by the ratio of the area of the crystal peak (1203 cm⁻¹) and the area of the amorphous peak (1172 cm⁻¹) which are obtained from the IR spectrum in each fragmented portion.

The crystallinity distributing in a dispersing state at least at the end part 12f of the inner face part 12d as described can lead to the improvement in strength of the adhesion between the mouthpiece 15 and the liner 12 without easy development in fracture even under shear stress. According to the inventor's findings, the crystallinity distributing in a dispersing state at the end part 12f can lead to this adhesive strength 75% higher than that in the form of layer.

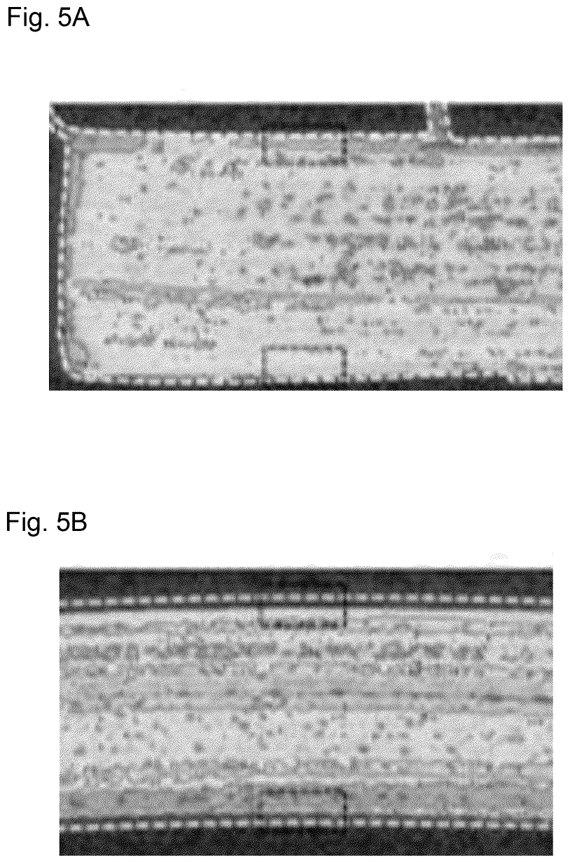

Such difference in distribution of the crystallinity can be also confirmed in orientation. FIGS. 5A and 5B show the distribution of orientation. FIG. 5A shows the distribution of the orientation in the same part as in FIG. 4A, and FIG. 5B shows the distribution of the orientation in the same part as in FIG. 4B. Here, the orientation distributes as showing the orientation state of the resin. Such distribution of the orientation state is obtained by the value of the infrared dichroic ratio such that the area of the crystal peak (1203 cm⁻¹) of the resin is obtained from the IR spectra of a sample which are measured via polarizing plates (0°, 90°).

As shown by the reference sign 12g in FIG. 3, a gate trace 12g is formed at the outer face part 12e of the liner 12 where an inlet for a molten resin flowing in in molding was positioned. FIG. 3 shows the gate trace 12g in a slightly exaggerating way. Usually, the gate trace 12g can be recognized when the liner 12 is molded by injection molding. Thus, a gate trace in a form as usual may be regarded as the gate trace 12g.

The outer face part 12e provided with the gate trace 12g means that, as described later, a molten resin flowed from the outer face part to the inner face part and reached the end part of the inner face part in molding. Thus, the molten resin is stopped and stirred at the end part of the inner face part, so that the crystallinity distributes as described above.

### 1.1.2. Reinforcing Layer

The reinforcing layer 13 is such that plural layers of fiber bundles that are made from a carbon fiber or the like and that is impregnated with a cured resin are laminated. Specifically, the reinforcing layer 13 is formed by winding the fiber bundles around the periphery of the liner 12 until the plural layers of the wound fiber bundles have a predetermined thickness. The thickness of the reinforcing layer 13 is not particularly limited because determined according to necessary strength, and is approximately 10 mm to 30 mm.

As the fiber with which the resin is reinforced, a carbon fiber or an aramid fiber (such as a poly-paraphenylene terephthalamide fiber) can be used. A glass fiber may be used as the fiber with which the resin is reinforced. As the resin reinforced with the fiber, a thermosetting resin such as an epoxy resin, an epoxy acrylate resin, and a polyester resin can be used.

### 1.2. Mouthpiece

The mouthpieces 15 are members fitted to the two openings of the liner 12, respectively. One of the mouthpieces 15 functions as an opening via which the inside and the outside of the high-pressure tank 10 communicate with each other. In addition, a valve is to be fitted to the one mouthpiece 15.

Therefore, at least the one of the mouthpieces 15, to which a valve is to be fitted, is provided with the hole 15a that has a circular cross section and that is for disposing the valve.

An inner face of the hole 15a is provided with a female thread 15b that corresponds to a male screw of a valve. A valve is fixed to the mouthpiece 15 by combining a male screw of the valve with this female thread 15b.

The inner surface of the hole 15a has a smooth sealed face 15c on a side thereof which is closer to the tank than the female thread 15b is (high-pressure side). If a sealing member provided around the circumference of the valve is in contact with this sealed face 15c, the high-pressure tank 10 becomes airtight (is sealed).

Further, the steplike part 15f having an increased diameter of the sealed face 15c is provided around the innermost end part (on the highest-pressure side) of the hole 15a of the mouthpiece 15 in the tank. The steplike part 15f is in the form having a difference in level from the sealed face 15c so that the diameter thereof is an increased diameter of the sealed face 15c. The steplike part 15f is placed all around an inner circumferential face of the end part of the hole 15a on the high-pressure side. The resin constituting the liner 12 is filled with the steplike part 15f to be the inner face part 12d.

The shape of the steplike part 15f is formed to fit the shape of the inner face part 12d.

The members that form the mouthpieces 15 are not particularly limited as long as having necessary strength, and examples include copper, iron, and aluminum. When used for the mouthpieces 15, aluminum is preferably anodized on part of the surface of each of the mouthpieces 15 which is in contact with the liner 12. On a coating by anodizing on aluminum, there is a porous layer, and thus, there are countless minute pores formed. The resin to form the liner penetrates into such minute pores in molding, which can thus further improve the adhesion.

### 2. Method of Producing Tank

For example, the above-described tank 10 can be produced as follows. A method of producing the tank S1 according to one example comprises the step of insert molding, the step of joining liner members, and the step of forming the reinforcing layer.

### 2.1. Step of Insert Molding

In the step of insert molding, the liner 12 where the mouthpieces 15 are disposed is formed by insert molding. In this step, a liner member having one mouthpiece 15 is made by putting the mouthpiece 15 onto a metal mold (not shown) as an insert part, and injection-molding a resin. Here, the liner member is half the total length (size along the axis L) of the liner 12. Further, another half of a liner member having the other mouthpiece 15 (mouthpiece without any hole) is made in the same way. Examples of the injected resin include thermosetting resins such as nylon and polyethylene as described above.

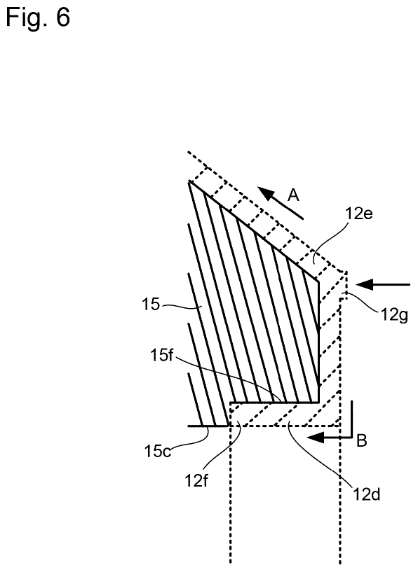

Here, as shown in FIG. 6, the resin is poured (injected) at the position corresponding to the gate trace 12g. According to this, the poured resin separates to flow into a channel around the outer face of the mouthpiece 15 as shown by A in FIG. 6, and a channel around the inner face of the mouthpiece 15 which reaches the steplike part 15f as shown by B in FIG. 6. The resin having reached the steplike part 15f impacts a wall formed by the difference in level between steplike part 15f and the sealed face 15c, which causes the flow to be turbulent. This can lead to the distribution of the crystallinity in a dispersing state at the end part 12f of the inner face part 12d of the liner 12 as described above.

As described, providing the inlet of the resin at a part to be at the outer face part, and subsequently, providing a part to be the inner face part can cause the flow of the resin to be controlled as described above to lead to the distribution of the crystallinity in a dispersing state at the end part of the inner face part.

### 2.2. Step of Joining Liner Members

In the step of joining liner members, the two liner members made in the insert step are joined.

In this step, an end part of the liner of one of the liner members is made to adjoin an end part of the liner of the other liner member, and the adjoining part of the two liners are irradiated with a laser with, for example, a laser torch. This results in the two liner members welded by the heated resin of the joined part of the two liner members.

In this case, preferably, one of the liner members is formed from a laser absorptive resin, and the other liner member is formed from a laser transmissive resin. This makes it easy to weld the two liner members. Further, in this case, preferably, the same resin material is used for the two liner members, and a pigment is added to the resin material for one of the liner members to give the one liner member laser absorbency. This is because there is no difference in strength between the two liner members when the same material is used for the two liner members. As a pigment as used herein, for example, carbon black or ferrous oxide (FeO) can be used.

### 2.3. Step of Forming Reinforcing Layer

In the step of forming the reinforcing layer, fiber bundles impregnated with a resin are wound around the outer face of the mouthpiece 15 which is outside the liner 12, and the liner 12. The mechanical properties of the tank can be adjusted according to the winding manner of the fiber bundles. After this, the resin in the wound fiber, which is impregnated with the resin, is heat-set to form the reinforcing layer 13.

### 3. Effect etc.

According to the present disclosure, the crystallinity distributes in a dispersing state at least at the end part of the liner on the inner side, which can improve the strength of the adhesion between the liner and the mouthpiece.

### REFERENCE SIGNS LIST

10 high-pressure tank
11 tank body
12 liner
12d inner face part
12e outer face part
13 reinforcing layer
15 mouthpiece
15c sealed face
15f steplike part

What is claimed is:

1. A method of producing a tank, the method comprising:
disposing, in a metal mold, a mouthpiece having a hole; and
pouring a resin into the metal mold via a gate, wherein
said pouring a resin causes the resin to separate to flow into a channel around an inner face of the hole of the mouthpiece from the gate, and a channel around an outer face of the mouthpiece from the gate.

2. The method of claim 1, wherein the resin flowing into the channel around the inner face of the hole reaches a steplike part of the mouthpiece and impacts a wall formed by a difference in level at the steplike part, causing the flow to be turbulent.

3. The method of claim 2, wherein the turbulent flow causes crystallinity of the resin to distribute in a dispersing state at an end part where the resin flow terminates.

4. The method of claim 1, wherein the gate is positioned at a location that forms a gate trace at an outer face part of a liner formed by the resin.

5. The method of claim 4, wherein the resin flows from the gate trace location to both the channel around the outer face of the mouthpiece and the channel around the inner face of the hole of the mouthpiece.

6. A method of producing a tank, the method comprising:
forming a liner by disposing, in a metal mold, a mouthpiece having a hole; and
pouring a resin into the metal mold via a gate, wherein
said pouring a resin causes the resin to separate to flow into a channel around an inner face of the hole of the mouthpiece from the gate, and a channel around an outer face of the mouthpiece from the gate.

7. The method of producing the tank of claim 6, wherein the liner has an inner face part that is a part extending around an inner face of the hole of the mouthpiece from an opening part of the hole of the mouthpiece, and an outer face part that is a part extending around an outer face of the mouthpiece from the opening part of the hole of the mouthpiece, and
at an end part of the inner face part, crystallinity of the liner distributes in a dispersing state but not in a form of layer.

8. The method of producing the tank of claim 7, wherein at an end part of the inner face part, crystallinity of the liner distributes in a dispersing state but not in a form of layer.

9. The method of producing the tank of claim 7, wherein the liner has a gate trace at the outer face part.

10. The method of claim 6, wherein the resin flowing into the channel around the inner face of the hole reaches a steplike part of the mouthpiece and impacts a wall formed by a difference in level at the steplike part, causing the flow to be turbulent.

11. The method of claim 10, wherein the turbulent flow causes crystallinity of the resin to distribute in a dispersing state at an end part where the resin flow terminates.

12. The method of claim 6, wherein the gate is positioned at a location that forms a gate trace at an outer face part of a liner formed by the resin.

13. The method of claim 12, wherein the resin flows from the gate trace location to both the channel around the outer face of the mouthpiece and the channel around the inner face of the hole of the mouthpiece.
